(19) United States
(12) Patent Application Publication
(10) Pub. No.: US 2018/0034283 A1
(43) Pub. Date: Feb. 1, 2018

(54) SYSTEMS AND METHODS TO INCREASE RATE OF CHARGE OF BATTERY BASED ON IMPEDANCE

(71) Applicant: Lenovo (Singapore) Pte. Ltd., New Tech Park (SG)

(72) Inventors: Bouziane Yebka, Apex, NC (US); Philip John Jakes, Durham, NC (US); Tin-Lup Wong, Chapel Hill, NC (US)

(21) Appl. No.: 15/220,606

(22) Filed: Jul. 27, 2016

(51) Int. Cl. H02J 7/00

(52) U.S. Cl. CPC H02J 7/007; H02J 2007/0001; H02J 2007/0096

(57) ABSTRACT

In one aspect, a device includes a processor, at least one system component accessible to the processor, a battery accessible to the processor and that provides power to the processor and to the at least one system component, and storage accessible to the processor. The storage bears instructions executable by the processor to initiate a charge of the battery at a first rate, receive impedance data pertaining to the battery, determine whether to increase the rate of charge of the battery based on the impedance data, and charge the battery at a second rate faster than the first rate in response to a determination to increase the rate of charge of the battery.

### FIELD

The present application relates generally to systems and methods to increase the rate of charge of a battery based on impedance.

### BACKGROUND

As recognized herein, it may sometimes be desirable to charge a battery of a device at a relatively faster rate than normal owing to various time constraints of the user, such as the user being in an airport and wishing to charge his or her device as much as possible before embarking on a long flight on which the user would like to use the device. However, as also recognized herein, sometimes the rate at which the battery is chargeable is limited by the temperature of the battery, since faster-rate charging is available at higher temperatures but sometimes not at lower temperatures without damaging the battery. So that the battery reaches such a higher temperature, preheating may be used to raise the battery's temperature, and/or charging at a relatively slower rate may be used to charge the battery and raise the battery's temperature at the same time owing to the charging. Both of these options can take too much time under certain circumstances, such as when a user does not have that much time to charge their device in the first place.

The present application also recognizes that to figure out when faster-rate charging is available, a device may monitor the “skin” temperature of the battery in that it may monitor a temperature of the battery externally from the battery and that pertains to, e.g., a temperature of the battery's surface. However, as recognized herein, this may not be ideal for fast-charging situations since the internal battery temperature may be more indicative of when fast-charging can begin but is difficult to measure, and it may take longer for the internal temperature to change the temperature at the battery's surface. This can cost a user valuable fast-rate charge time that would otherwise be useable for charging the battery when the user has little time to spare.

### SUMMARY

Accordingly, in one aspect a device includes a processor, at least one system component accessible to the processor, a battery accessible to the processor and that provides power to the processor and to the at least one system component, and storage accessible to the processor. The storage bears instructions executable by the processor to initiate a charge of the battery at a first rate, receive impedance data pertaining to the battery, determine whether to increase the rate of charge of the battery based on the impedance data, and charge the battery at a second rate faster than the first rate in response to a determination to increase the rate of charge of the battery.

In another aspect, a method includes monitoring impedance of a battery disposed in a device, with the impedance being monitored while the battery is being charged at a first rate. The method also includes increasing, based on the monitoring of impedance, charging of the battery from the first rate to a second rate faster than the first rate.

In still another aspect, a computer readable storage medium that is not a transitory signal comprises instructions executable by a processor to monitor impedance of a battery disposed in a device, with the impedance being monitored while the battery is being charged at a first rate. The instructions are also executable by the processor to increase, based on the impedance, charging of the battery from the first rate to a second rate faster than the first rate.

The details of present principles, both as to their structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is an example block diagram of a network of devices in accordance with present principles;

FIG. 3 is a flow chart of an example algorithm in accordance with present principles; and

FIGS. 4 and 5 are example user interfaces (UIs) in accordance with present principles.

### DETAILED DESCRIPTION

It is to be understood that a battery in accordance with present principles may be capable of charging at a “normal” rate (e.g., C/3) in which charging does not harm the battery or cause undesirable side effects or damage, other than normal wear and tear. However, this same battery may also be capable of charging at one or more relatively faster rates than the normal rate (e.g., 2 C to 10 C), but as recognized herein, it may not always be optimal to charge the battery at one of the faster rates when charging is initiated, depending on the battery's temperature and/or impedance, owing to various types of battery malfunctions and/or chemical degradation that may occur. Nonetheless, the present application recognizes that fast-charging a battery can provide certain benefits, such as to sufficiently charge the battery when the user does not have enough time to let the device charge at the normal rate, and so there may be instances where impedance may be used to monitor the battery's response to the device incrementally increasing the charging rate.

Accordingly, disclosed herein are systems and methods to increase the rate of charge of a battery (e.g., a lithium ion battery) based on impedance rather than skin temperature since, e.g., resistance may vary some based on battery temperature variances. Thus, in at least some instances, a change in the battery's impedance may reflect a change in the internal temperature of the battery. By monitoring impedance and changes thereof, a device undertaking present principles may be able to more quickly determine when the rate of charging the battery can be increased from a relatively lower rate to thus provide a fast-charging instance.

With respect to any computer systems discussed herein, a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple, Google, or Microsoft. A Unix or similar such as Linux operating system may be used. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware; hence, illustrative components, blocks, modules, circuits, and steps are sometimes set forth in terms of their functionality.

A processor may be any conventional general purpose single- or multi-chip processor that can execute logic by means of various lines such as address lines, data lines, and control lines and registers and shift registers. Moreover, any logical blocks, modules, and circuits described herein can be implemented or performed, in addition to a general purpose processor, in or by a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can be implemented by a controller or state machine or a combination of computing devices.

Any software and/or applications described by way of flow charts and/or user interfaces herein can include various sub-routines, procedures, etc. It is to be understood that logic divulged as being executed by, e.g., a module can be redistributed to other software modules and/or combined together in a single module and/or made available in a shareable library.

Logic when implemented in software, can be written in an appropriate language such as but not limited to C# or C++, and can be stored on or transmitted through a computer-readable storage medium (e.g., that is not a transitory signal) such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “circuit” or “circuitry” may be used in the summary, description, and/or claims. As is well known in the art, the term “circuitry” includes all levels of available integration, e.g., from discrete logic circuits to the highest level of circuit integration such as VLSI, and includes programmable logic components programmed to perform the functions of an embodiment as well as general-purpose or special-purpose processors programmed with instructions to perform those functions.

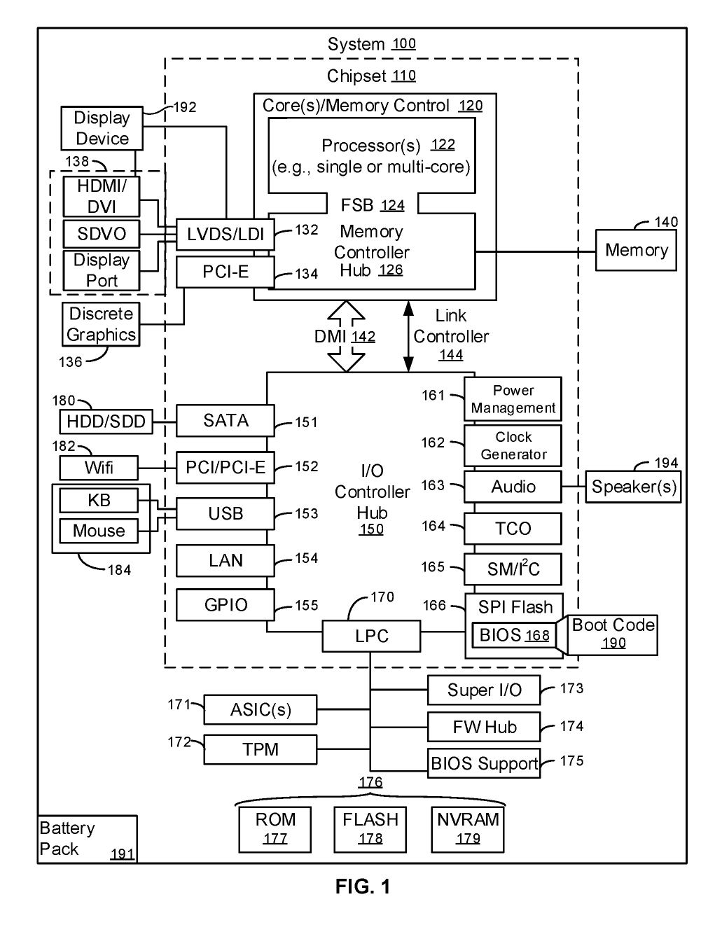

Now specifically in reference to FIG. 1, an example block diagram of an information handling system and/or computer system 100 is shown. Note that in some embodiments the system 100 may be a desktop computer system, such as one of the ThinkCentre® or ThinkPad® series of personal computers sold by Lenovo (US) Inc. of Morrisville, N.C., or a workstation computer, such as the ThinkStation®, which are sold by Lenovo (US) Inc. of Morrisville, N.C.; however, as apparent from the description herein, a client device, a server or other machine in accordance with present principles may include other features or only some of the features of the system 100. Also, the system 100 may be, e.g., a game console such as XBOX®, and/or the system 100 may include a wireless telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 include one or more processors 122 (e.g., single core or multi-core, etc.) such as a central processing unit (CPU), and a memory controller hub 126 that exchange information via a front side bus (FSB) 124. As described herein, various components of the core and memory control group 120 may be integrated onto a single processor die, for example, to make a chip that supplants the conventional “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. Discrete graphics using a PCI-E interface has become an alternative approach to an accelerated graphics port (AGP). For example, the memory controller hub 126 may include a 16-lane (x16) PCI-E port for an external PCI-E-based graphics card (including, e.g., one of more GPUs). An example system may include AGP or PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more USB interfaces 153, a LAN interface 154 (more generally a network interface for communication over at least one network such as the Internet, a WAN, a LAN, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes BIOS 168 and boot code 190. With respect to network connections, the I/O hub controller 150 may include integrated gigabit Ethernet controller lines multiplexed with a PCI-E interface port. Other network features may operate independent of a PCI-E interface.

The interfaces of the I/O hub controller 150 may provide for communication with various devices, networks, etc. For example, where used, the SATA interface 151 provides for reading, writing or reading and writing information on one or more drives 180 such as HDDs, SDDs or a combination thereof, but in any case the drives 180 are understood to be, e.g., tangible computer readable storage mediums that are not transitory signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, the system 100 may also include at least one battery pack 191 comprising at least one battery and/or battery cell. The battery pack 191 may be, for instance, in jelly roll format. It may also be in pouch cell format in which the strip(s) of active material are folded. In either case, in accordance with present principles the battery may be a Lithium ion battery or another type of battery.

Furthermore, the battery pack 191 may be electrically coupled to and power the system 100 to power system components, and can also be electrically coupled to at least one charge receiver on the system 100 for receiving a charge from a power source via a battery charger to charge one or more battery cells in the pack 191. Thus, the charge receiver itself can include at least one circuit configured for receiving power (e.g., from a wall outlet via a charger) and doing at least one of: providing power to the system 100 to power it, and providing power to the battery pack 191 to charge at least one battery in the pack 191.

The battery pack 191 may also include a battery management unit/system (BMU) that itself may include elements such as a processor, random access memory (RAM), and non-volatile storage bearing instructions executable by the BMU's processor. The processors 122 and/or the BMU may, independently or in conjunction with each other, control the rate of charge that the at least one battery undergoes during charging in accordance with present principles.

The battery pack 191 may further include one or more sensors juxtaposed with the battery(s)/battery cells for sensing and measuring things related to the battery pack 191 and/or battery within, such as voltage (e.g., charge and discharge voltage), electric potential, impedance, state of charge, temperature (e.g., via a temperature sensor/thermocouple), etc. The sensors may provide input/measurements to the BMU's processor and/or the processor(s) 122.

Additionally, though not shown for clarity, in some embodiments the system 100 may include a gyroscope that senses and/or measures the orientation of the system 100 and provides input related thereto to the processor 122, an accelerometer that senses acceleration and/or movement of the system 100 and provides input related thereto to the processor 122, an audio receiver/microphone that provides input from the microphone to the processor 122 based on audio that is detected, such as via a user providing audible input to the microphone, and a camera that gathers one or more images and provides input related thereto to the processor 122. The camera may be a thermal imaging camera, a digital camera such as a webcam, a three-dimensional (3D) camera, and/or a camera otherwise integrated into the system 100 and controllable by the processor 122 to gather pictures/images and/or video. Still further, and also not shown for clarity, the system 100 may include a GPS transceiver that is configured to receive geographic position information from at least one satellite and provide the information to the processor 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

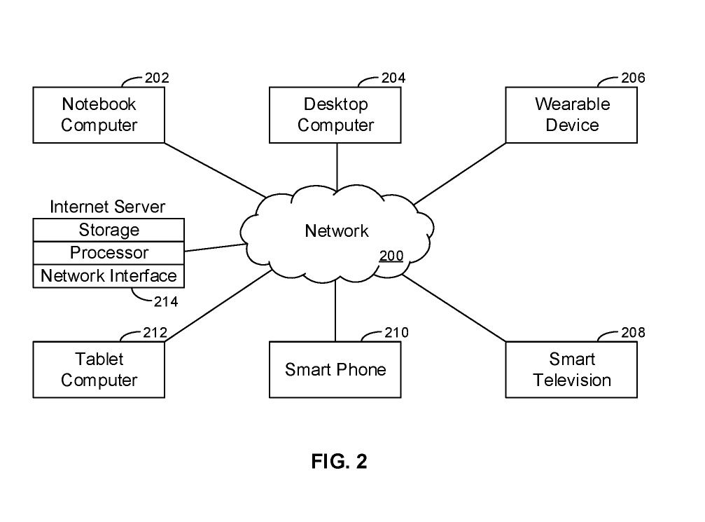

Turning now to FIG. 2, example devices are shown communicating over a network 200 such as the Internet in accordance with present principles. It is to be understood that each of the devices described in reference to FIG. 2 may include at least some of the features, components, and/or elements of the system 100 described above.

FIG. 2 shows a notebook computer and/or convertible computer 202, a desktop computer 204, a wearable device 206 such as a smart watch, a smart television (TV) 208, a smart phone 210, a tablet computer 212, and a server 214 such as an Internet server that may provide cloud storage accessible to the devices 202-212. It is to be understood that the devices 202-214 are configured to communicate with each other over the network 200 to undertake present principles.

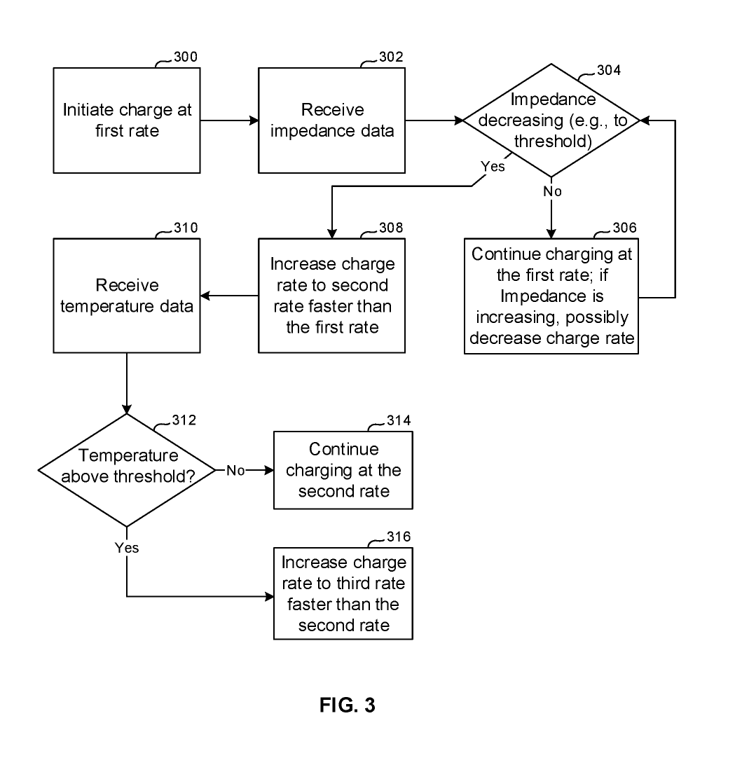

Referring to FIG. 3, it shows example logic that may be executed by a device such as the system 100 in accordance with present principles for monitoring battery impedance and determining whether and when to increase a charge rate for charging the device's battery. Beginning at block 300, the logic initiates a charge of the battery at a first rate. The first rate may be a default rate for initiating charging of the battery, and/or a predetermined rate for initially charging the battery prior to increasing to a faster charge.

From block 300 the logic may move to block 302, where the device may receive impedance data pertaining to impedance of the device's battery. In embodiments where the present logic is executed by the device's CPU and/or main processor(s), the impedance data may be received directly from one or more impedance sensors juxtaposed with the device's battery to measure impedance of the battery. In addition to or in lieu of the foregoing, when the present logic is executed by the device's CPU and/or main processor(s), the impedance data may be received from the battery's BMU, which itself may receive the impedance data from an impedance sensor and/or otherwise determine impedance of the battery.

In embodiments where all or part of the present logic is executed by the device's BMU specifically, the BMU may receive the impedance data from the one or more impedance sensors juxtaposed with the device's battery.

After block 302 the logic may move to decision diamond 304. At diamond 304 the logic may determine whether to increase the rate of charge of the battery at least by determining, based on the impedance data that is received, whether impedance of the battery is decreasing, such as by any amount since charging began or an incremental amount since charging began. In some embodiments the determination at diamond 304 may even be based on whether impedance of the battery has decreased by at least a threshold amount from a higher impedance amount when charging began, and/or whether impedance of the battery has decreased to a threshold, predetermined impedance amount from a higher impedance amount when charging began.

In addition to or in lieu of the foregoing, in some embodiments, the determination at diamond 304 may be based on whether impedance of the battery is at least at or below a threshold amount even if impedance has not decreased to that amount since charging began. This may be the case if the temperature of the battery is already relatively higher owing to, e.g., device use that generates heat affecting battery temperature and/or contact with a person that generates heat affecting battery temperature, which in turn may lead to a relatively lower impedance than had the battery's temperature been lower when charging began.

Before moving on in the description of FIG. 3, it is to be understood that state logic may be used for various portions of the logic of FIG. 3, such as for diamond 304, although the logic is disclosed in flow chart format.

In any case, responsive to a negative determination at diamond 304, the logic of FIG. 3 may move to block 306. At block 306 the logic may continue charging the device's battery at the first rate. However, in some embodiments the logic may even decrease the charge rate from the first rate to a slower rate if it is determined that impedance has increased instead or is increasing instead, though in other embodiments the logic may continue to charge the battery at the first rate even if impedance has increased. From block 306 the logic may revert back to diamond 304 where it may continue monitoring impedance and proceed therefrom as described above.

Responsive to an affirmative determination at diamond 304, the logic may instead move to block 308. At block 308 the logic may increase the charge rate for the battery from the first rate to a second rate faster than the first rate. The second rate may be faster than a default and/or normal charge rate. Furthermore, in some embodiments the second rate may be a rate just under a rate for fast charging that is invocable by a user in circumstances when the user does not have the time to let the device's battery sufficiently charge at the normal rate.

From block 308 the logic may next proceed to block 310. At block 310 the logic may receive temperature data pertaining to a temperature of the battery, such as via a temperature sensor/thermocouple. In embodiments where the present logic is executed by the device's CPU and/or main processor(s), the temperature data may be received directly from one or more temperature sensors juxtaposed with the device's battery to measure temperature of the battery, such as a skin temperature of the battery. In addition to or in lieu of the foregoing, when the present logic is executed by the device's CPU and/or main processor(s), the temperature data may be received from the battery's BMU, which itself may receive the temperature data from a temperature sensor/thermocouple and/or otherwise determine a temperature of the battery.

In embodiments where all or part of the present logic is executed by the device's BMU specifically, the BMU may receive the temperature data from the one or more temperature sensors/thermocouples juxtaposed with the device's battery.

From block 310 the logic may move to decision diamond 312. At diamond 312 the logic may determine whether to further increase the rate of charge of the battery at least by determining, based on the temperature data, whether a temperature associated with the battery has reached or increased beyond a threshold, preconfigured temperature (such as twenty three degrees Celsius). Responsive to a negative determination at diamond 312, the logic may move to block 314 where the logic may continue charging at the second rate. From block 314 the logic may then revert back to diamond 312 and proceed therefrom as described above.

However, responsive to an affirmative determination at diamond 312, the logic of FIG. 3 may instead move to block 316, where the logic may increase the charge rate for the battery to a third rate faster than the second rate and hence also faster than the first rate. The third rate may be a rate for fast charging invocable by a user in circumstances when the user does not have the time to let the device's battery sufficiently charge at the normal rate, such as a charge rate in the range of 2 C to 5 C.

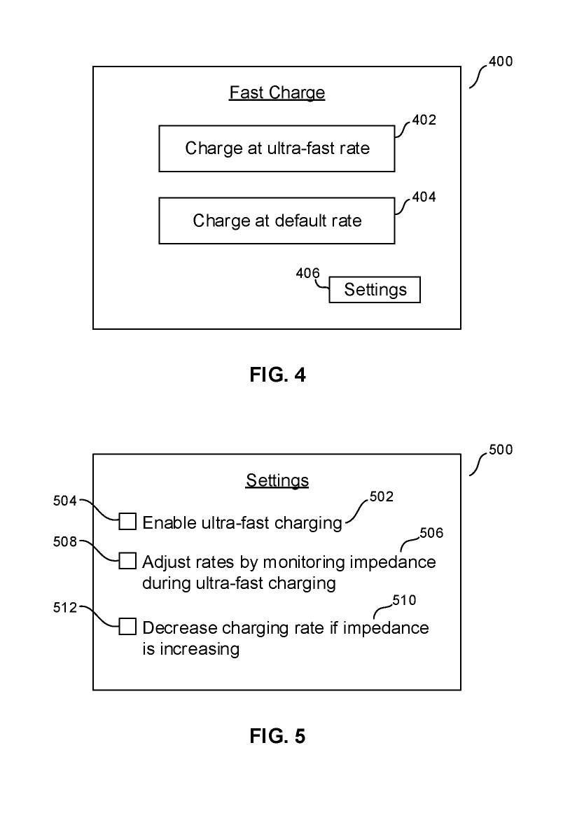

Continuing the detailed description in reference to FIG. 4, it shows an example user interface (UI) 400 presentable on a display controlled by a device undertaking present principles, where the UI 400 may be manipulable to control charging of the device's battery. Thus, the UI 400 may include a first selector 402 that is selectable for a user to command the device to initiate charging of the device's battery at an “ultra-fast” charge rate, assuming the device is engaged with a power source for charging the battery. The ultra-fast charge rate may be a charge rate that is faster than a normal and/or default rate for charging the battery, and that is useful in certain circumstances to charge the battery quickly when the user may not have much time available for charging. In any case, it is to be understood that responsive to selection of the selector 402, the device may initiate a charge of the battery per the logic of FIG. 3 described above.

The UI 400 may also include a selector 404 that is selectable for a user to command the device to initiate charging of the battery at the normal and/or default charge rate, assuming the device is engaged with a power source for charging the battery. Thus, responsive to selection of the selector 404, the device may initiate a charge of the battery at the normal and/or default rate.

The UI 400 may also include a selector 406. The selector 406 may be selectable to command the device to present a settings UI on the display, an example of which is shown in FIG. 5. The UI 500 shown in FIG. 5 may be manipulable by a user to configure settings for the device in accordance with present principles.

Thus, the UI 500 includes a first option 502 enableable based on user input to check box 504 to enable fast charging of the device's battery, such as, e.g., the ultra-fast charging discussed above. The UI 500 may also include a second option 506 that is enableable based on user input to check box 508 to enable adjustment of charge rates based on monitoring of the battery's impedance during fast-rate charging (e.g., as set forth above in reference to FIG. 3). Still further, the UI 500 may include an option 510 enableable based on user input to check box 512 to enable the device to decrease a charging rate for the battery when the device detects that impedance is increasing rather than decreasing as set forth herein.

Before concluding, it is to be understood that although a software application for undertaking present principles may be vended with a device such as the system 100, present principles apply in instances where such an application is downloaded from a server to a device over a network such as the Internet. Furthermore, present principles apply in instances where such an application is included on a computer readable storage medium that is being vended and/or provided, where the computer readable storage medium is not a transitory signal and/or a signal per se.

It is to be understood that whilst present principals have been described with reference to some example embodiments, these are not intended to be limiting, and that various alternative arrangements may be used to implement the subject matter claimed herein. Components included in one embodiment can be used in other embodiments in any appropriate combination. For example, any of the various components described herein and/or depicted in the Figures may be combined, interchanged or excluded from other embodiments.

What is claimed is:

1. A device, comprising:
a processor;
at least one system component accessible to the processor;
a battery accessible to the processor, wherein the battery provides power to the processor and to the at least one system component; and
storage accessible to the processor and bearing instructions executable by the processor to:
initiate a charge of the battery at a first rate;
receive impedance data pertaining to the battery;
based on the impedance data, determine whether to increase the rate of charge of the battery; and
in response to a determination to increase the rate of charge of the battery, charge the battery at a second rate faster than the first rate.

2. The device of claim 1, wherein the instructions are executable by the processor to:
determine whether to increase the rate of charge of the battery based on whether impedance of the battery is one of above a threshold and below the threshold.

3. The device of claim 1, wherein the instructions are executable by the processor to:
determine to increase the rate of charge of the battery based on identification, using the impedance data, of impedance of the battery decreasing.

4. The device of claim 1, wherein the instructions are executable by the processor to:
determine to increase the rate of charge of the battery in response to identification, using the impedance data, of impedance of the battery decreasing.

5. The device of claim 1, comprising a battery management unit (BMU) in communication with the battery, and wherein the impedance data is received from the BMU.

6. The device of claim 1, comprising an impedance sensor juxtaposed with the battery to measure impedance of the battery, and wherein the impedance data is received from the impedance sensor.

7. The device of claim 6, comprising a battery management unit (BMU) in communication with the battery, wherein the BMU comprises the processor, and wherein the instructions are executable by the processor of the BMU.

8. The device of claim 6, wherein the processor is a central processing unit (CPU), and wherein the instructions are executable by the CPU.

9. The device of claim 1, wherein the instructions are executable by the processor to:
while the battery is charging at the second rate, receive temperature data; and
based on the temperature data, determine whether a temperature has at least reached a threshold; and
in response to a determination that the temperature has at least reached the threshold, charge the battery at a third rate faster than the second rate.

10. The device of claim 1, comprising a display accessible to the processor, and wherein the instructions are executable by the processor to:
initiate the charge of the battery in response to receipt of user input to a user interface (UI) presented on the display, the UI being manipulable to control charging of the battery.

11. The device of claim 10, wherein the UI is manipulable to control charging of the battery using at least one rate faster than a default rate for charging the battery.

12. The device of claim 1, wherein the instructions are executable by the processor to:
determine to decrease the rate of charge of the battery from the first rate to a third rate slower than the first rate based on identification, using the impedance data, of impedance of the battery increasing.

13. A method, comprising:
monitoring impedance of a battery disposed in a device, the impedance being monitored while the battery is being charged at a first rate; and
increasing, based on the monitoring of impedance, charging of the battery from the first rate to a second rate faster than the first rate.

14. The method of claim 13, comprising:
increasing the charging of the battery to the second rate based on impedance of the battery decreasing.

15. The method of claim 13, comprising:
increasing the charging of the battery to the second rate based on impedance of the battery decreasing to at least a threshold amount.

16. The method of claim 13, comprising:
determining whether to increase the charging of the battery to the second rate based on whether impedance of the battery is one of above a threshold amount and below the threshold amount; and
increasing charging of the battery to the second rate in response to determining that that impedance of the battery is below the threshold amount.

17. The method of claim 13, comprising:
monitoring impedance of the battery based at least in part on one or more of: data from a battery management unit (BMU) associated with the battery, and data from an impedance sensor juxtaposed with the battery.

18. The method of claim 13, comprising:
monitoring, while the battery is charging at the second rate, temperature associated with the battery; and
increasing, based on the monitoring of temperature, charging of the battery from the second rate to a third rate faster than the second rate.

19. A computer readable storage medium that is not a transitory signal, the computer readable storage medium comprising instructions executable by a processor to:
monitor impedance of a battery disposed in a device, the impedance being monitored while the battery is being charged at a first rate; and
increase, based on the impedance, charging of the battery from the first rate to a second rate faster than the first rate.

20. The computer readable storage medium of claim 19, wherein the instructions are executable by the processor to:
increase, based impedance of the battery decreasing, charging of the battery to the second rate;
monitor, while the battery is charging at the second rate, temperature associated with the battery; and
increase, based on the monitoring of temperature, charging of the battery from the second rate to a third rate faster than the second rate.
